(19) United States
(12) Patent Application Publication
(10) Pub. No.: US 2006/0277537 A1
(43) Pub. Date: Dec. 7, 2006

(54) Deployment of containers and container extensions in a modular code runtime platform through a runtime platform extension point

(75) Inventors: Sheldon Y. Chan, Somerville, MA (US); Andrew E. Davis, Arlington, MA (US); Keith A. Kimball, Hollis, NH (US); Melaquias E. Martinez, Boylston, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/142,647

(22) Filed: Jun. 1, 2005

(51) Int. Cl. G06F 9/44

(52) U.S. Cl. 717/168

(57) ABSTRACT

Embodiments of the present invention address deficiencies of the art in respect to deploying components in a modular code runtime environment and provide a method, system and computer program product for deploying containers and container extensions in a modular code runtime environment, such as the Eclipse integrated development environment. In one embodiment, a container extension deployment system can include a container, a registry of container extensions slated for deployment in the container, and a deployment plug-in to a modular code runtime environment coupled to the registry. The deployment plug-in can include an extension point configured for use by other plug-ins. The extension point, in turn, can include container extensions slated for deployment in the container. Finally, the container extensions can include services that implement an interface for starting and stopping the services and libraries in an archive.

### CROSS-REFERENCE TO RELATED APPLICATIONS

This patent application claims the benefit under 35 U.S.C. §120 as a continuation-in-part of presently pending U.S. patent application Ser. No. 11/101,105, entitled DEPLOYMENT OF REUSABLE SOFTWARE COMPONENTS TO BE HOSTED IN A CONTAINER RUNNING ON A MODULAR CODE RUNTIME PLATFORM THROUGH A RUNTIME PLATFORM EXTENSION POINT, filed on Apr. 7, 2005, the entire teachings of which are incorporated herein by reference

### BACKGROUND OF THE INVENTION

1. Field of the Invention

The present invention relates to deployment of componentized application logic in an application framework and more particularly to the deployment of containers and container extensions in a modular code runtime environment.

2. Description of the Related Art

Enterprise application servers are containers for deploying componentized application logic and services. In particular, enterprise application servers provide a common framework and re-usable set of underlying container services to componentized application logic. Generally, componentized application logic can include reusable software components. Examples of reusable software components include visual components manufactured by Borland Software Corporation of Scotts Valley, Calif., and the venerable bean ordinarily associated with the Java programming language.

An enterprise form of the bean is a Java 2 Platform, Enterprise Edition (J2EE) platform component that implements enterprise Java bean (EJB) technology. Specifically, an enterprise bean is a server-side component that encapsulates the business logic of an application. The business logic is the code that fulfills the purpose of the application. By invoking these methods, remote clients can access the inventory services provided by the application. Notably, enterprise beans run in an EJB container, a runtime environment within the J2EE server.

Services, like EJB technology, can include logic to perform a specific task. In EJB technology, the bean can be accessed directly by a programmatically coupled client. The communicatively coupled client must have knowledge of the interface of the bean in order to access the logic of the bean. Services, unlike beans however, are not accessed directly by client logic. Rather, services are objects instantiated by the container independent of any one EJB that provides an extension of the container functionality. Services are typically accessed by EJBs through an asynchronous mechanism such as a message queue or event bus. In this way, services are to be viewed as extensions to the container as they provide additional functionality to application logic deployed within the container.

A service is embodied as a code element that is instantiated and run, independent of EJBs or other clients that might invoke or utilize its functionality. Thus, the service enjoys an independent execution lifecycle. A library, by comparison, is embodied as a code element that only executes in response to invocation by an EJB. That is, the library is loaded, executed and terminated in response to a method invocation. Hence, a library can be distinguished from a service in respect to the different execution lifecycles. Unlike services, however, the logic of the library can only be accessed by clients within the same container. Still, like services, libraries, too, are to be viewed as extensions to the container as they provide additional functionality to application logic deployed within the container.

In the J2EE environment, the deployment and registration of EJBs can be accomplished in a container through a vendor specific user interface or customized application installation process. When integrating a container into a modular code runtime platform, it would be advantageous to provide an aggregation/registration mechanism that enables deployment of shared libraries using the code module framework of the host platform. That is, it would be useful to be able to package the shared libraries using the code module format supported by the host platform. These shared libraries ought to be automatically installed into the EJB container when their code modules are installed into the host platform as part of the existing plug-in provisioning and update mechanisms. Similarly, it would be advantageous to provide an aggregation/registration mechanism that enables registration and management of services using the code module framework of the host platform. These EJBs ought to be automatically started and stopped in the EJB container when their code modules are installed into the host platform as part of the existing plug-in provisioning and update mechanisms.

Likewise, when integrating a container that may include multiple running instances into a modular code runtime platform, it would be advantageous to provide a configuration/instantiation mechanism that enables multiple container instances to be created using the code module framework of the host platform. That enables compartmentalization of servers associated with disparate problem domains or incompatible implementation models. These instances of the EJB server need to be deployed and instantiated on the host platform as part of the existing plug-in provisioning and update mechanisms.

### BRIEF SUMMARY OF THE INVENTION

Embodiments of the present invention address deficiencies of the art in respect to deploying components in a modular code runtime environment and provide a novel and non-obvious method, system and computer program product for deploying containers and container extensions in a modular code runtime environment, such as the Eclipse integrated development environment. In one embodiment, a container and container extension deployment system can include a container such as an application server instance, a registry of container extensions slated for deployment in the container, and a deployment plug-in to a modular code runtime environment coupled to the registry. The deployment plug-in can include an extension point configured for use by other plug-ins. The extension point, in turn, can include container extensions slated for deployment in the container. Finally, the container extensions can include services that implement an interface for starting and stopping the services and libraries in an archive.

In another embodiment of the invention, a container and container extension deployment system can include a server manager, a registry of containers, such as application server instances, which are slated for deployment by the server manager, and a deployment plug-in to the modular code runtime environment coupled to the registry. The deployment plug-in can include an extension point configured for use by other plug-ins. The extension point, in turn, can include containers such as application server instances slated for deployment by the server manager in the modular code runtime environment. Optionally, each of the other plug-ins can include a bundle of containers and a manifest referencing the extension point and listing the containers which are to be registered in the registry through the deployment plug-in.

Embodiments of the invention can include methods for deploying both containers and container extensions in a modular code runtime environment. For example, a method for deploying container extensions in a modular code runtime environment can include identifying container extensions to be deployed in a container in the modular code runtime environment. The method also can include registering the container extensions in a registry in the modular code runtime environment. Finally, the method can include deploying registered ones of said container extensions into the container in the modular code runtime environment.

By comparison, a method for deploying containers such as application servers in a modular code runtime environment can include identifying containers to be deployed in the modular code runtime environment. The method also can include registering the containers in a registry in the modular code runtime environment. Finally, the method can include deploying instances of registered ones of the containers into the modular code runtime environment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a modular code runtime platform configured for container extension deployment through an extension point;

FIG. 2 is a flow chart illustrating a process for container extension deployment in a modular code runtime platform through an extension point;

FIG. 3 is a schematic illustration of a modular code runtime platform configured for the deployment of multiple containers through an extension point; and,

FIG. 4 is a flow chart illustrating a process for deploying multiple containers in a modular code runtime platform through an extension point.

### DETAILED DESCRIPTION OF THE INVENTION

Embodiments of the present invention provide a method, system and apparatus for container and container extension deployment in a modular code runtime platform through an extension point. In accordance with an embodiment of the invention, a deployment plug-in can be installed into the modular code runtime platform. The deployment plug-in can expose an extension point for registering both container extensions, such as services and shared libraries, and also containers, such as application server instances, for deployment in the modular code runtime platform. In this regard, during startup of the modular code runtime platform, the deployment plug-in can refer to the registry to identify container and container extensions slated for deployment and to manage the verification and deployment of the registered containers and container extensions into the modular code runtime platform.

The skilled artisan will recognize several advantages of the foregoing arrangement. First, the modular code runtime platform can become a host for an enterprise application server instance that can be updated and modified by provisioning plug-ins to change which services execute in the container and which shared libraries are available. Also, the reusable software component container of the modular code runtime platform can provide a local, client-side execution context for reusable software components that would normally be remotely accessed by a client. Hence, substantial off-line processing of client-server applications can be enabled within the modular code runtime platform in consequence of the present invention.

Also, in an embodiment of the invention, the modular code runtime platform can be a host for multiple instances of containers such as enterprise application servers that can be updated or modified through provisioning plug-ins to the modular code runtime platform. As such, an embedded application can provide a local, client-side execution context for EJBs or other server application components that would normally be remotely accessed by the client. This, in turn, enables off-line processing of client-server applications in multiple isolated server instances and allows for local, embedded replicas of each server to run independently within the client for off-line access to those services.

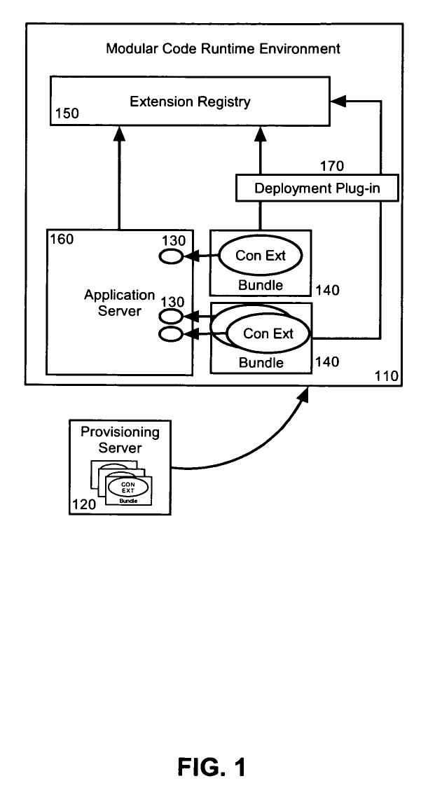

In further illustration of the present invention, FIG. 1 is a schematic illustration of a modular code runtime platform configured for container extension deployment through an extension point. As shown in FIG. 1, an extension registry 150 can be disposed in a modular code runtime platform 110. The modular code runtime environment 110 can expose an extension point for use by one or more provisioning servers 120 in deploying container extensions 130 to a container 160 such as an enterprise application server instance operating within the modular code runtime environment 110. As an example, the container extensions 130 can include either shared libraries, or services which implement a service interface:

```
public interface IContainerService
{
    public void start( );
    public void stop( );
}
```

Optionally, a deployment plug-in 170 can be programmed to write entries in the extension registry 150 for the container extensions 130 which are to be deployed in the container 160. To determine which container extensions 130 are to be deployed, the deployment plug-in 170 also can include logic programmed to parse provisioned plug-in bundles 140. Each of the bundles can contain one or more of the container extensions 130 and a manifest (not shown) declaring not only the presence of the container extensions 130, but also the extension point exposed by the deployment plug-in 170.

For instance, where the container extensions 130 are services, a manifest pointing to the extension point “org.example.bean.platform.providers” for the modular code runtime platform “org.example.bean.platform” which identifies for deployment the service “exampleservice1” included in the archive “exampleservice.jar” can include:

```
<extension id=“org.example.bean.example_beans”
        name=“Provider for Service Example”
        point=“org.example.bean.platform.providers”>
    <service name=“Example Service”
        serviceClass=“org.example.bean.exampleservice1 ”
        id=“org.example.bean.exampleservice1 ”>
    </service>
</extension>
```

By comparison, where the container extensions 130 are shared libraries, a manifest pointing to the extension point “org.example.bean.platform.providers” for the modular code runtime platform “org.example.bean.platform” which identifies for deployment the shared library “examplelib1” included in the archive “examplelib.jar” can include:

```
<extension id=“org.example.bean.example_beans”
        name=“Provider for Shared Library Example”
        point=“org.example.bean.platform.providers”>
    <libname=“Example Shared Library”
        uri=“lib\examplelib.jar”
        id=“org.example.bean.examplelib1 ”>
    </lib>
</extension>
```

While parsing the manifest for each of the plug-in bundles 140, the deployment plug-in 170 can identify container extensions 130 to be deployed in the container 160 and can write registry entries for each of the identified ones of the container extensions 130. Subsequently, during the startup of the modular code runtime platform 110, the container 160 can process the extension registry 150 to identify the container extensions 130 slated for deployment. Once identified, the container extensions 130 can be located and loaded into the container 160 for operation within the modular code runtime environment 110.

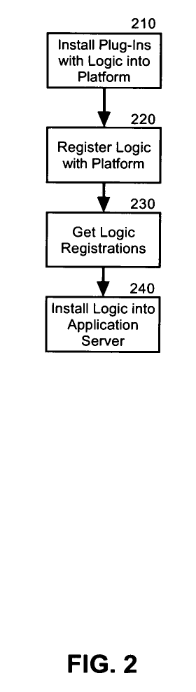

In further illustration of the process of the invention, FIG. 2 is a flow chart illustrating a process for container extension deployment in a modular code runtime platform through an extension point. Beginning in block 210, each plug-in containing one or more container extensions to be deployed into the modular code runtime environment can be installed into the modular code runtime environment. In block 220, upon installation, the container extension or extensions of each plug-in can be registered in the extension registry of the modular code runtime environment. In block 230, the container can observe the registrations and in block 240, using the registry information, the container can load the container extension or extensions referred to in the registry into the container.

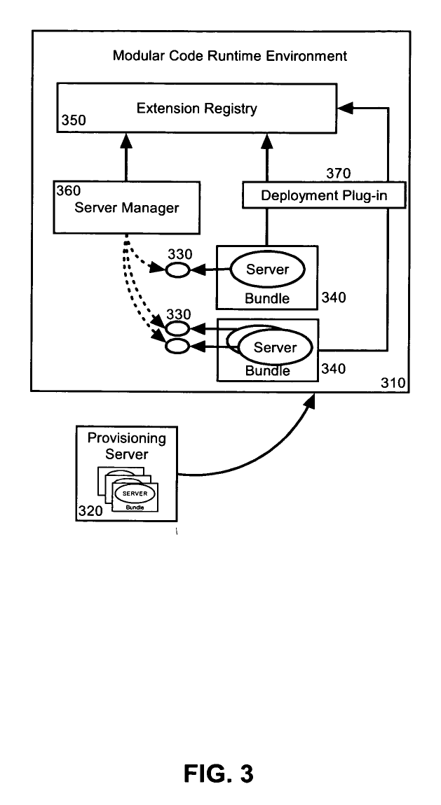

Referring now to FIG. 3, a schematic illustration of a modular code runtime platform configured for the deployment of multiple containers through an extension point is shown. As shown in FIG. 3, an extension registry 350 can be disposed in a modular code runtime platform 310. The modular code runtime environment 310 can expose an extension point for use by one or more provisioning servers 320 in deploying one or more containers 330, for example application server instances, through a server manager 360 operating within the modular code runtime environment 310. Specifically, the server manager 360 can be a plug-in to the modular code runtime environment 310 that exposes an extension-point and publishes a public interface for registering containers 130 for instantiation.

Optionally, a deployment plug-in 370 can be programmed to write entries in the extension registry 350 for the containers 330 which are to be deployed by the server manager 360. To determine which containers 330 are to be deployed, the deployment plug-in 370 also can include logic programmed to parse provisioned plug-in bundles 340. Each of the bundles can contain the containers 330 and a manifest (not shown) declaring not only the presence of the containers 330, but also the extension point exposed by the deployment plug-in 370.

For instance, a manifest pointing to the extension point “org.example.bean.platform.providers” for the modular code runtime platform “org.example.bean.platform” which identifies for deployment the application server “exampleserver1” included in the archive “exampleserver.jar” can include:

```
<extension id=“org.example.bean.example_beans”
        name=“Provider for Application Server Example”
        point=“org.example.bean.platform.providers”>
    <server name=“Example Application Server Instance”
        serviceClass=“ org.example.bean.exampleserver1 ”
        id=“org.example.bean.exampleserver1 ”>
    </server>
</extension>
```

While parsing the manifest for each of the plug-in bundles 340, the deployment plug-in 370 can identify containers 330 to be deployed in the by the server manager 360 and can write registry entries for each of the identified ones of the containers 330. Subsequently, during the startup of the modular code runtime platform 310, the server manager 360 can process the extension registry 350 to identify the containers 330 slated for deployment. Once identified, the containers 330 can be located and loaded by the server manager 360 for operation within the modular code runtime environment 310.

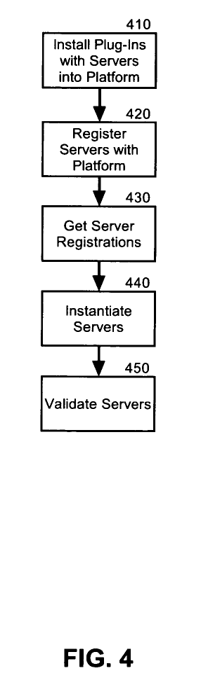

In further illustration of the process of the invention, FIG. 4 is a flow chart illustrating a process for multiple container deployment in a modular code runtime platform through an extension point. Beginning in block 410, each plug-in containing a container or containers to be deployed into the modular code runtime environment can be installed into the modular code runtime environment. In block 420, upon installation, the container or containers of each plug-in can be registered in the extension registry of the modular code runtime environment. In block 430, the enterprise server manager can observe the registrations and in block 440, using the registry information, the server manager can load the container or containers referred to in the registry into the modular code runtime platform.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In a modular code runtime environment, a container extension deployment system comprising:
a container;
a registry of container extensions slated for deployment in said container; and,
a deployment plug-in to the modular code runtime environment coupled to said registry and comprising an extension point configured for use by other plug-ins comprising container extensions slated for deployment in said container.

2. The system of claim 1, wherein at least one of said container extension comprises services that implement an interface for starting and stopping said services.

3. The system of claim 1, wherein at least one of said container extensions comprises libraries in an archive.

4. The system of claim 1, wherein each of said other plug-ins comprises a bundle of container extensions and a manifest referencing said extension point and listing said container extensions which are to be registered in said registry through said deployment plug-in.

5. The system of claim 1, wherein the modular code runtime platform is the Eclipse integrated development environment.

6. A method for deploying container extensions in a modular code runtime environment, the method comprising the steps of:
identifying container extensions to be deployed in a container in the modular code runtime environment;
registering said container extensions in a registry in the modular code runtime environment; and,
deploying registered ones of said container extensions into said container in the modular code runtime environment.

7. The method of claim 6, wherein said identifying step comprises the steps of:
exposing an extension point to a plug-in to the modular code runtime environment; and,
receiving extensions to said exposed extension point, each extension specifying a service to be deployed in said container in the modular code runtime environment.

8. The method of claim 6, wherein said identifying step comprises the steps of:
exposing an extension point to a plug-in to the modular code runtime environment; and,
receiving extensions to said exposed extension point, each extension specifying a library to be deployed in said container in the modular code runtime environment.

9. The method of claim 7, wherein said receiving step comprises the step of parsing a manifest for a bundle for each extension, said bundle comprising a service, said manifest listing said service and referencing said extension point.

10. The method of claim 8, wherein said receiving step comprises the step of parsing a manifest for a bundle for each extension, said bundle comprising a library, said manifest listing said library and referencing said extension point.

11. The method of claim 6, wherein the modular code runtime platform is the Eclipse integrated development environment.

12. A computer program product comprising a computer usable medium including computer usable program code for deploying logic in a modular code runtime environment, said computer program product including:
computer usable program code for identifying container extensions to be deployed in a container in the modular code runtime environment;
computer usable program code for registering said container extensions in a registry in the modular code runtime environment; and,
computer usable program code for deploying registered ones of said container extensions into said container in the modular code runtime environment.

13. The computer program product of claim 12, wherein said computer usable program code for identifying container extensions to be deployed in a container in the modular code runtime environment comprises:
computer usable program code for exposing an extension point to a plug-in to the modular code runtime environment; and,
computer usable program code for receiving extensions to said exposed extension point, each extension specifying a service to be deployed in said container in the modular code runtime environment.

14. The computer program product of claim 12, wherein said computer usable program code for identifying container extensions to be deployed in a container in the modular code runtime environment comprises:
computer usable program code for exposing an extension point to a plug-in to the modular code runtime environment; and,
computer usable program code for receiving extensions to said exposed extension point, each extension specifying a library to be deployed in said container in the modular code runtime environment.

15. The computer program product of claim 13, wherein said computer usable program code for receiving extensions to said exposed extension point comprises computer usable program code for parsing a manifest for a bundle for each extension, said bundle comprising a service, said manifest listing said service and referencing said extension point.

16. The computer program product of claim 14, wherein said computer usable program code for receiving extensions to said exposed extension point comprises computer usable program code for parsing a manifest for a bundle for each extension, said bundle comprising a library, said manifest listing said library and referencing said extension point.

17. The computer program product of claim 12, wherein the modular code runtime platform is the Eclipse integrated development environment.

18. In a modular code runtime environment, a container deployment system comprising:
a server manager;
a registry of containers slated for deployment by said server manager; and,
a deployment plug-in to the modular code runtime environment coupled to said registry and comprising an extension point configured for use by other plug-ins comprising containers slated for deployment by the server manager in the modular code runtime environment.

19. The system of claim 18, wherein each of said other plug-ins comprises a bundle of containers and a manifest referencing said extension point and listing said containers which are to be registered in said registry through said deployment plug-in.

20. The system of claim 18, wherein the modular code runtime platform is the Eclipse integrated development environment.

21. A method for deploying containers in a modular code runtime environment, the method comprising the steps of:
identifying containers to be deployed in the modular code runtime environment;
registering said containers in a registry in the modular code runtime environment; and,
deploying registered ones of said containers into the modular code runtime environment.

22. The method of claim 21, wherein said identifying step comprises the steps of:
exposing an extension point to a plug-in to the modular code runtime environment; and,
receiving extensions to said exposed extension point, each extension specifying a container to be deployed in the modular code runtime environment.

23. The method of claim 22, wherein said receiving step comprises the step of parsing a manifest for a bundle for each extension, said bundle comprising at least one container, said manifest listing said at least one container and referencing said extension point.

24. The method of claim 21, wherein the modular code runtime platform is the Eclipse integrated development environment.

25. A computer program product comprising a computer usable medium including computer usable program code for deploying containers in a modular code runtime environment, said computer program product including:
computer usable program code for identifying containers to be deployed in the modular code runtime environment;
computer usable program code for registering said containers in a registry in the modular code runtime environment; and,
computer usable program code deploying registered ones of said containers into the modular code runtime environment.

26. The computer program product of claim 25, wherein said computer usable program code for identifying containers to be deployed in the modular code runtime environment comprises:
computer usable program code for exposing an extension point to a plug-in to the modular code runtime environment; and,
computer usable program code for receiving extensions to said exposed extension point, each extension specifying a container to be deployed in the modular code runtime environment.

27. The computer program product of claim 25, wherein said computer usable program code for receiving extensions to said exposed extension point comprises computer usable program code for parsing a manifest for a bundle for each extension, said bundle comprising at least one container, said manifest listing said at least one container and referencing said extension point.

28. The computer program product of claim 25, wherein the modular code runtime platform is the Eclipse integrated development environment.
